(19) United States
(12) Patent Application Publication
(10) Pub. No.: US 2021/0001158 A1
(43) Pub. Date: Jan. 7, 2021

(54) PROTECTIVE HOOD

(71) Applicant: Toray Industries, Inc., Tokyo (JP)

(72) Inventors: Emiko Ishikawa, Osaka-shi, Osaka (JP); Nobutoshi Fujihara, Otsu-shi, Shiga (JP); Yuichiro Hayashi, Otsu-shi, Shiga (JP)

(73) Assignee: Toray Industries, Inc., Tokyo (JP)

(21) Appl. No.: 16/969,737

(22) PCT Filed: Feb. 22, 2019
(86) PCT No.: PCT/JP2019/006731

§ 371 Date: Aug. 13, 2020

(30) Foreign Application Priority Data
Mar. 1, 2018 (JP) 2018-036187

(51) Int. Cl. A62B 18/04; A42B 1/04; A62B 17/04; A62B 18/08; A41D 13/11; A41D 31/14

(52) U.S. Cl. CPC A62B 18/04; A42B 1/048; A62B 17/04; A62B 17/00; A41D 13/1153; A41D 31/145; A62B 18/084

(57) ABSTRACT

A protective hood that can be easily worn and that has an excellent degree of contact is described, where the protective hood includes: a hood that covers the head of the wearer; an opening formed at a position corresponding to the face of the wearer; and a latching tool A that can be latched around the head of the wearer and is provided on the upper side of the opening.

### CROSS REFERENCE TO RELATED APPLICATIONS

This is the U.S. National Phase application of PCT/JP2019/006731, filed Feb. 22, 2019, which claims priority to Japanese Patent Application No. 2018-036187, filed Mar. 1, 2018, the disclosures of these applications being incorporated herein by reference in their entireties for all purposes.

### FIELD OF THE INVENTION

The present invention relates to a protective hood that can be easily donned and doffed, and has a high degree of contact to a head and a face.

### BACKGROUND OF THE INVENTION

When working in the presence of external harmful substances such as dust, radioactivity and viruses, protective clothing and protective hoods are worn for protection therefrom. On the other hand, in food factories and clean rooms, protective clothing and protective hoods are worn for the purpose of keeping particulate diffusion and filthy matter such as hair from the human body in. In both cases, the order of wearing has been complicated, and it has often been troublesome to wear them. Additionally, since the protective clothings and protective hoods need to be worn in an overlapped manner, the wearer has often felt stuffy and uncomfortable after wearing them for a long time. Among the equipment, particularly the protective hood has made it difficult to breathe since it covers the head and face, and has often obstructed the field of view when performing detailed work.

Against this background, there have been proposed a “medical hood device with mask” (Patent Document 1) including a soft hood that allows fixing bands at both ends of a mask to be hooked on the earlobes or head of the human body outside the hood, a “dustproof hood” (Patent Document 2) including integrated protective glasses for the eyes and an integrated mask for the nose and mouth, and “dustproof hoods” (Patent Document 3), (Patent Document 4) that allow the wearer to easily don and doff a mask while wearing the hood, for example.

However, the hood device described in Patent Document 1 is such that a mask is integrally provided on a hood main body, and a visible material such as a transparent material is also integrally provided at a position of the hood main body corresponding to the human eyes. Hence, there has been a problem in terms of donning and doffing, degree of contact of the hood to the human body, and securing of the visible area. Additionally, the dustproof hood described in Patent Document 2 has protective glasses and a mask integrally incorporated in a hood main body, and prevents displacement between the human body and the protective equipment by providing ear hooks and a nose hook for hooking the protective glasses and the mask inside the hood. However, problems still remain in terms of donning and doffing, contact of the hood to the human body, and securing of the visible area.

On the other hand, in the hoods described in Patent Document 3 and Patent Document 4 which are supposed to be worn at a food site or the like, methods for opening mouth and nose portions when smelling and tasting food have been devised. However, in the hood described in Patent Document 3, a position corresponding to an upper part of the human eye part is formed in an arch shape with a stretchable belt-shaped material or the like to prevent the hair or eyebrows from being exposed to the outside. On such an arch, a force is always applied toward the inside. Additionally, the hood described in Patent Document 4 also uses stretchable fabric in a peripheral edge portion of an opening corresponding to the eyes, nose, and mouth, and in such a peripheral edge portion, a force is always applied toward the inside of the opening. For this reason, in the hoods described both of the documents, the hood itself may cover the eyes when the hood wearer works while moving the head to the right and left. Hence, there has been a problem in terms of degree of contact and securing of the visible area.

### PRIOR ART DOCUMENTS

### Patent Documents

Patent Document 1: Japanese Utility Model Registration No. 3110058
Patent Document 2: Japanese Patent Laid-open Publication No. 2013-253344
Patent Document 3: Japanese Patent Laid-open Publication No. 2014-237907
Patent Document 4: Japanese Patent No. 6051125

### SUMMARY OF THE INVENTION

An object of the present invention is to provide a protective hood that is improved in such drawbacks of the conventional techniques, can be easily worn, and has excellent degree of contact.

In order to solve the above problems, the present invention has any of the following configurations (1) to (11).

(1) A protective hood including: a hood that covers a head of a wearer; an opening formed at a position corresponding to a face of the wearer; and a latching tool A that can be latched around the head of the wearer and is provided on an upper side of the opening.

(2) The protective hood according to (1) above, in which the hood has a latching tool B on each of right and left sides of the opening, and the latching tool B is a belt-shaped material, a part of the latching tool B being connected to one of the right and left sides, and another part of the latching tool B being connected or being connectable to the latching tool A.

(3) The protective hood according to (1) above further including a mask that covers the nose and mouth of the wearer, in which the opening is formed by the hood and the mask, and the mask is connected to the hood below the opening.

(4) The protective hood according to (3) above further including a belt-shaped material on each of right and left sides of the mask, in which the belt-shaped material is connected or is connectable to the latching tool A.

(5) The protective hood according to (3) or (4) above, in which the mask is made of a nonwoven fabric having a water vapor transmission rate of 200 g/m²·h or more and 2000 g/m²·h or less.

(6) The protective hood according to any one of (3) to (5) above, in which the mask is made of a nonwoven fabric having an air permeability of 20 cm³/cm²/sec or more and 200 cm³/cm²/sec or less, and a dust collection efficiency of 80% or more.

(7) The protective hood according to any one of (1) to (6) above, in which the hood is made of a nonwoven fabric having a water vapor transmission rate of 200 g/m²·h or more and 2000 g/m²·h or less.

(8) The protective hood according to any one of (1) to (7) above, in which the hood is made of a nonwoven fabric having an air permeability of 20 cm³/cm²/sec or more and 200 cm³/cm²/sec or less, and a dust collection efficiency of 80% or more.

(9) The protective hood according to any one of (1) to (8) above, in which the hood is formed by stitching together a fabric forming a portion corresponding to the top of the head and a fabric forming a portion corresponding to the side of the head.

(10) The protective hood according to any one of (1) to (9) above, in which the protective hood is disposable.

(11) Protective clothing including the protective hood according to any one of (1) to (10) above being attached.

The protective hood of the present invention has an opening formed at a position corresponding to the face of a wearer, and a latching tool A that can be latched around the head of the wearer and is provided on the upper side of the opening. Hence, excellent degree of contact of the hood to the wearer can be achieved. Also, a latching tool B of a belt-shaped material is provided on each of the right and left sides of the opening of the hood, and a part of the latching tool B is connected to the right and left side and another portion of the latching tool B is connected or may be connectable to the latching tool A. In such a case, degree of contact and ease in donning and doffing are enhanced even more.

Additionally, even when the protective hood of the present invention has a hood and a mask, an opening is formed by the hood and the mask, and the mask is connected below the opening, excellent degree of contact of the hood to the wearer can be achieved by providing the latching tool A that can be donned and doffed easily and can be latched around the wearer's head on the upper side of the opening. Also, when a belt-shaped material is provided on each of the right and left sides of the mask, and the belt-shaped material is connected or is connectable to the latching tool A, the degree of contact and ease in donning and doffing are enhanced even more.

Additionally, when the hood or mask is made of a nonwoven fabric with a water vapor transmission rate of 200 g/m²·h or more and 2000 g/m²·h or less, it will not get stuffy even after being worn for a long time while working outdoors or in a hot and humid place indoors, for example.

### BRIEF DESCRIPTION OF THE DRAWINGS

FIG. 1 is a diagram showing No. 15 bizygomatic breadth A in the Japanese body size data book.

FIG. 2 is a diagram showing No. 8 gnathion to glabella height B in the Japanese body size data book.

FIG. 3 is a front view of a protective hood showing an embodiment of the present invention.

FIG. 4 is a front view of a protective hood showing an embodiment of the present invention.

FIG. 5 is a front view of protective clothing showing an embodiment of the present invention.

FIG. 6 is a front view of a protective hood showing an embodiment of the present invention.

FIG. 7 is an enlarged view of a mask portion of the protective hood showing an embodiment of the present invention.

FIG. 8 is a front view of protective clothing showing an embodiment of the present invention.

FIG. 9 is a shape diagram of a general hood.

### DETAILED DESCRIPTION OF EMBODIMENTS OF THE INVENTION

Hereinafter, embodiments of the present invention will be specifically described with reference to the drawings.

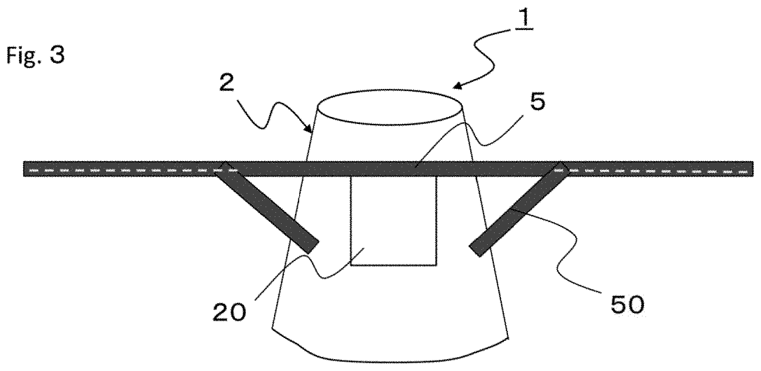

A protective hood of the present invention has, for example, as shown in FIG. 3, a hood 2 that covers the head of the wearer. The hood 2 has an opening 20 formed at a position corresponding to the face of the wearer, and a latching tool 5 (latching tool A) that can be latched around the head and provided on the upper side of the opening 20. By forming the opening 20 at a position corresponding to the wearer's face, the eyes, nose, and mouth can be exposed, and the latching tool 5 can enhance degree of contact of the hood to the face around the opening 20.

The latching tool 5 may be any device as long as it can be latched around the head, and examples thereof include latching tools such as a string, rubber, and tape-like materials (bias tape, twilled tape, hook-and-loop fastener, and the like). Additionally, a double-sided tape may be provided on ends of the latching tool, so that the latching tool can be latched onto the hood main body. The wearer can pull a part of the hood corresponding to the forehead and side surfaces of the hood together, whereby the number of wearing steps can be reduced and the degree of contact can be improved.

The latching tool 5 preferably has a structure that can be latched while applying tension, such as pulling and stopping both right and left ends of the belt-shaped material along the circumference of the head. Both ends of the belt-shaped material may be crossed and tied at the back of the head, a hook-and-loop fastener or a double-sided tape may be attached to the ends of the belt-shaped material so that both ends of the belt-shaped material are in contact with each other and fixed, or the double-sided tape may be attached to sides of the head and fixed. Note that the belt-shaped material needs to have a length equal to or more than the circumference of the wearer's head in the case where both ends thereof are fixed by crossing or contacting each other.

Moreover, it is preferable that the hood 2 be provided with latching tools 50 (latching tools B) of belt-shaped materials on the right and left sides of the opening 20. Preferably, a part of the latching tool 50 (latching tool B) of the belt-shaped material is connected to the right and left side described above, and another part of the latching tool 50 (latching tool B) is connected or is connectable to the latching tool 5 (latching tool A). As a result, the two latching tools 5, 50 (latching tools A, B) are connected or are connectable at each of the right and left sides of the head.

Although the material of the latching portions 5, 50 may be the same fabric as the hood 2 or a material different from that of the hood 2, the same fabric as the hood 2 is preferably used to reduce cost, make the most of the material characteristics, and avoid problems in sterilization processing after sewing.

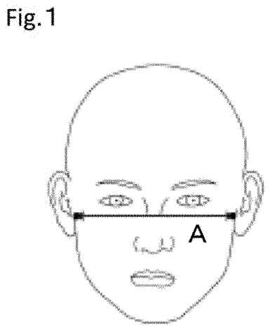

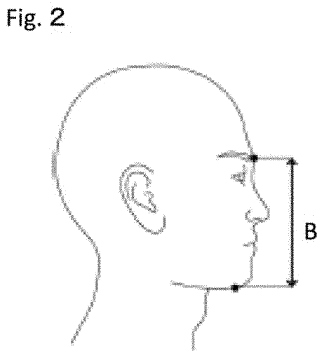

The size of the opening 20 is preferably 13 cm to 16 cm in width (horizontal direction), more preferably about 15 cm. The length (vertical direction) of the opening is preferably 9 cm to 13 cm, more preferably 11 cm to 12 cm. These are figures determined by referring to the Japanese body size data book 2004-2006 published by the Research Institute of Human Engineering for Quality Life. The width direction is based on a bizygomatic breadth A shown in FIG. 1 and the length direction is based on a gnathion to glabella height B shown in FIG. 2, the sizes being such that exposure is minimized and the line of sight is not hindered.

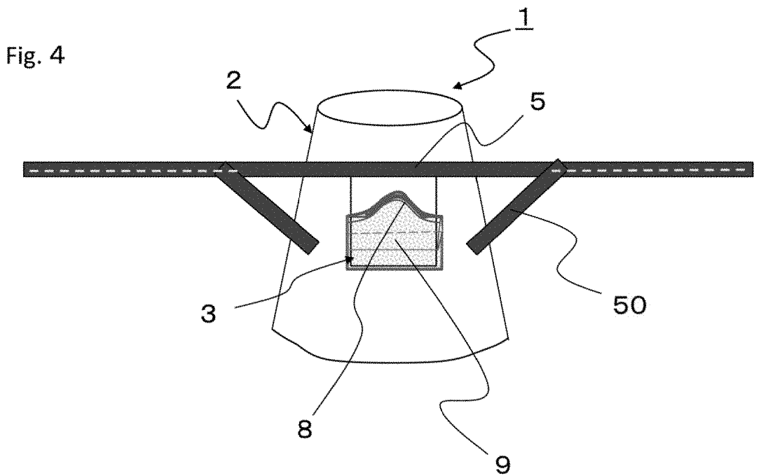

In the present invention, it is also possible to connect a mask 3 to the hood 2 so as to cover a lower portion of the opening 20 as shown in FIG. 4, that is, to cover the nose and mouth of the wearer. With this configuration, the mask-integrated protective hood can be worn easily.

As shown in FIG. 4, the mask 3 preferably has an arcuate upper side, where a protruding portion 1.0 cm to 2.0 cm higher than the right and left sides is formed in a central portion (position corresponding to wearer's nose). With such a configuration, degree of contact to the nose can be improved. Moreover, by inserting a nose wire 8 into the upper side of the mask, the mask 3 can be brought into closer contact with the nose. Additionally, by adding a tuck 9 in the horizontal direction of the mask, the mask 3 can be worn by attaching another three-dimensional mask inside the protective hood for more secure protection, or the mask can be kept from sticking to the mouth and causing stuffiness. The tuck is preferably provided within the range of 2 cm or more and 8 cm or less, that is, an excess fabric amount of 2 to 8 cm is preferably divided into 1 to 4 tucks.

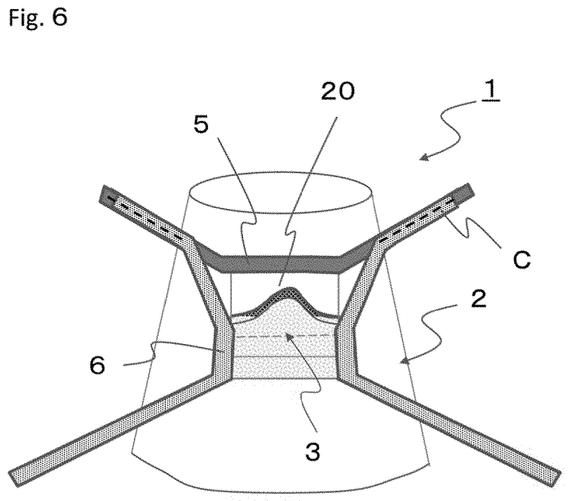

Also, as the mask-integrated protective hood, a mode as shown in FIG. 6, for example, is also preferable. A protective hood 1 shown in FIG. 6 has a hood 2 that covers the head of the wearer and a mask 3 that covers the nose and mouth of the wearer, and the hood 2 and the mask 3 form an opening 20 at a position corresponding to the face of the wearer. The protective hood 1 also has a latching tool 5 that can be latched around the head on the upper side of the opening 20. Additionally, the mask 3 that covers the nose and mouth is connected to the hood 2 below the opening 20. Since the protective hood of the present invention has the opening 20 at the center of the hood corresponding to the face so that the eyes are exposed, the field of view can be secured even if the exposed portion is covered with goggles, a film, or the like.

In the protective hood 1 as shown in FIG. 6, the size of the opening 20 is preferably 13 cm to 16 cm in width (horizontal direction when worn), for example. Additionally, the length (vertical direction when worn) of the opening is preferably 2.0 cm to 6.0 cm, more preferably 3.0 cm to 5.0 cm. These are figures determined by referring to the Japanese body size data book 2004-2006 published by the Research Institute of Human Engineering for Quality Life. The width direction is based on a bizygomatic breadth A shown in FIG. 1 and the length direction is based on a gnathion to glabella height B shown in FIG. 2, the sizes being derived from the viewpoint of minimizing exposure and not hindering the line of sight.

Also, in the protective hood of the present invention as shown in FIG. 6, in order to enhance the degree of contact of the hood to the face around the opening 20 that exposes the eyes, a latching tool 5 is provided on the upper side of the opening 20. By providing the latching tool 5, the hood can be brought into close contact with the forehead, and the hood can be prevented from being displaced when the head and neck are moved to the right and left. In a case where there is no latching tool 5 on the upper side, a gap is formed between the hood and the forehead especially when moving, and it is difficult to prevent entry of contaminants from the inside and the outside with high precision.

Similar to the latching tool 5 described with reference to FIG. 3, the latching tool 5 may be any device as long as it can be latched around the head, and examples thereof include belt-shaped materials such as a string, rubber, or tape-shaped materials (bias tape, twilled tape, hook-and-loop fastener, and the like). Additionally, a double-sided tape may be provided on ends of the belt-shaped material so that it can be latched.

Additionally, the latching tool 5 may have any structure that can be latched while applying tension, such as pulling and stopping both right and left ends of the belt-shaped material along the circumference of the head. For example, both ends of the belt-shaped material may be crossed and tied at the back of the head, a hook-and-loop fastener or a double-sided tape may be attached to the ends of the belt-shaped material so that both ends of the belt-shaped material are in contact with each other and fixed, or the double-sided tape may be attached to sides of the head and fixed. Note that the belt-shaped material needs to have a length equal to or more than the circumference of the wearer's head in the case where both ends thereof are fixed by crossing or contacting each other.

Also in the protective hood as shown in FIG. 6, although the material of the latching portion 5 may be the same fabric as the hood or a material different from that of the hood, the same fabric as the hood main body is preferably used to reduce cost, make the most of the material characteristics, and avoid problems in sterilization processing after sewing.

Moreover, in the protective hood of the present invention as shown in FIG. 6, the degree of contact of the mask can be increased by arranging belt-shaped materials 6 extending in the vertical direction on the right and left sides of the mask connected to the opening 20. As shown in FIG. 6, the belt-shaped material 6 is preferably integrated with the latching tool 5 by stitching (C in FIG. 6), above the mask and at a position corresponding to the side of the head, for example. As a result, the wearer can pull a part of the hood corresponding to the forehead and the mask together, whereby the number of wearing steps can be reduced and the degree of contact can be improved. Note that when connecting the latching tool 5 and the belt-shaped material 6, the parts only need to be connected before the wearer wears the protective hood of the present invention. Hence, it is also preferable to add a hook-and-loop fastener or a double-sided tape to enable connection, so that the positional relationship between the latching tool 5 and the belt-shaped material 6 can be changed to fit the size of the wearer.

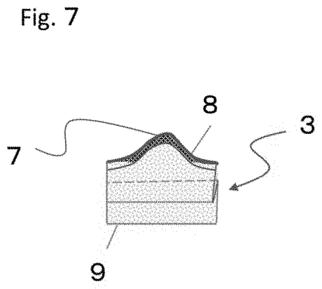

As shown in FIG. 7, the mask 3 used for the protective hood shown in FIG. 6, also preferably has an upper side formed in an arcuate shape 7, where a protruding portion 1.0 cm to 2.0 cm higher than the right and left sides is formed in a central portion (position corresponding to wearer's nose). With such a configuration, degree of contact to the nose can be improved. Moreover, by inserting a nose wire 8 into the upper side of the mask, the mask 3 can be brought into closer contact with the nose. Additionally, by adding a tuck 9 in the horizontal direction of the mask, the mask 3 can be worn by attaching another three-dimensional mask inside the protective hood for more secure protection, or the mask can be kept from sticking to the mouth and causing stuffiness. The tuck is preferably provided within the range of 2 cm or more and 8 cm or less, that is, an excess fabric amount of 2 to 8 cm is preferably divided into 1 to 4 tucks.

Since the protective hood of the present invention as described above has a simple structure in every mode, it can be worn quickly. In particular, while it is necessary to wear protective clothing and a protective hood quickly so that they do not come into contact with the floor and wall surface when wearing in a clean room or the like, according to the protective hood of the present invention and protective clothing with the protective hood stitched thereto, the above can be made easier.

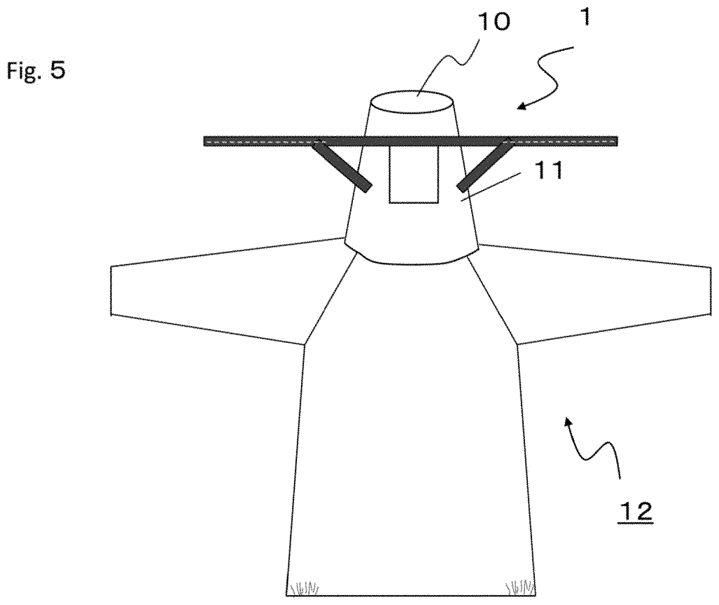

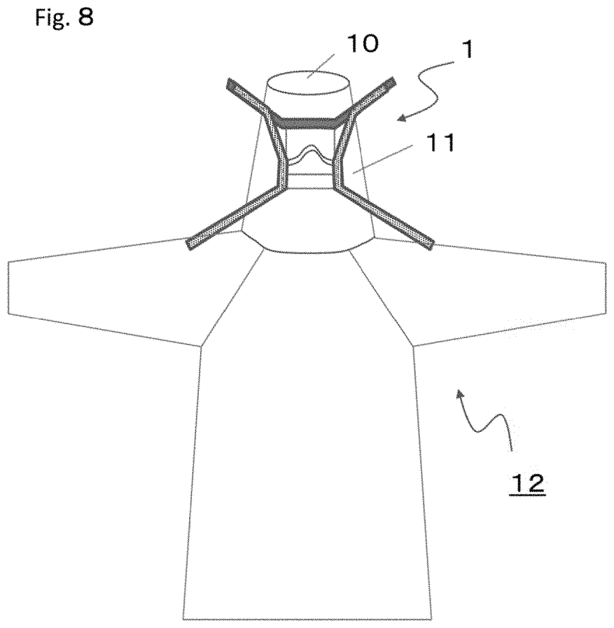

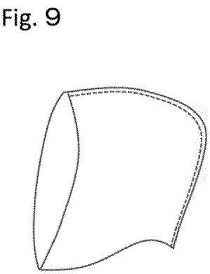

As shown in FIGS. 5 and 8, for example, the protective hood of the present invention can be configured by stitching together a substantially circular fabric 10 forming a portion corresponding to the top of the head, and a substantially trapezoidal fabric 11 forming a portion corresponding to the side of the head. With such a configuration, the protective hood can be brought into closer contact with the head. Generally, hoods are often formed by stitching together right and left two fabrics of the same shape as shown in FIG. 9. In this case, it is difficult to fix the correct position of the forehead, and since the head moves inside the hood when the head is moved, the hood obstructs the field of view and tends to cause discomfort in wearing.

Additionally, when using a protective hood, goggles or protective glasses are usually used to protect eyes. With the protective hood of the present invention, the gap between such goggles or protective glasses and a mask can be reduced significantly. Additionally, instead of wearing goggles or protective glasses, a film with high visibility may be stitched to the opening 20. At that time, fogging occurs due to the outflow of exhaled air from the mask, so it is preferable to use a film that has been subjected to antifogging processing.

The protective hood of the present invention can be used as a component of protective clothing 12 as shown in FIGS. 5 and 8. In terms of comfort in wearing, it is preferable that the material used for the protective hood and/or protective clothing for both the hood 2 and the mask 3 be a nonwoven fabric having a water vapor transmission rate of 200 g/m²·h or more and 2000 g/m²·h or less. When the water vapor transmission rate is less than 200 g/m²·h, it tends to get stuffy and the wearer tends to feel discomfort. Additionally, when the water vapor transmission rate exceeds 2000 g/m²·h, the dust collection efficiency is poor, which is not preferable as protective clothing.

Moreover, the material used for the hood 2 and/or the mask 3 is preferably a nonwoven fabric having an air permeability of 20 cm³/cm²/sec or more and 200 cm³/cm²/sec or less and a dust collection efficiency of 80% or more. When an air permeability of the nonwoven fabric is less than 20 cm³/cm²/sec, it tends to get stuffy and the wearer feels discomfort. When an air permeability of the nonwoven fabric exceeds 200 cm³/cm²/sec, the dust collection efficiency is poor and it may be difficult to prevent entry of contaminants from the inside and the outside.

Examples of the material (fabric composition) used for the protective hood and/or protective clothing of the present invention include a nonwoven fabric single layer and a laminate using a nonwoven fabric. As an example of the laminate, a three-layer laminate having an SMS structure (spunbonded nonwoven fabric/meltblown nonwoven fabric/spunbonded nonwoven fabric) and an SFS structure (spunbonded nonwoven fabric/film/spunbonded nonwoven fabric) is well known. The SMS structure or the SFS structure is one of the preferred forms, since it is possible to use a functional material in the middle layer, the spunbonded nonwoven fabric of the front and back layers can serve as a protective layer from the outside, and can give texture and softness.

There is no particular limitation on how to make the protective hood or how to attach the protective hood to the protective clothing. For example, fusion sewing using ultrasonic waves, machine sewing using sewing thread, or adhesive sewing using adhesive tape may be performed, and the method can be selected according to the application.

It is also preferable that the protective hood and/or protective clothing is disposable. Since contaminants may adhere to the exterior of the protective clothing, it is preferable to dispose of it every time it is undressed in terms of safety; and for that purpose, it is more preferable to use a low-cost nonwoven fabric. Of course, it is possible to use low-cost woven or knitted fabrics, but in the case of woven or knitted fabrics, it is necessary to treat frayed material edges, and lint and dust may come out from that part. Hence, it is more preferable to use a nonwoven fabric that does not have frayed edges.

### EXAMPLE

Hereinafter, the present invention will be described more specifically with reference to examples and comparative examples, but the present invention is not limited thereto. Note that the quality of the protective hood used in the examples and comparative examples was evaluated by the following method.

(Measuring Method)

(1) Water Vapor Transmission Rate

The water vapor transmission rate of the material was measured according to JIS L 1099:2012 “Testing methods for water vapor permeability of textiles”, method A-1 (calcium chloride method), and evaluated in units of g/m²·h.

(2) Air Permeability

Based on the Frazier type method JIS L 1913:2010 6.8.1, the amount of air passing through a test piece with a size of 15 cm×15 cm was measured at N=3, and the average value was used as the air permeability.

(3) Collection Efficiency

Samples for measurement at 10 locations were collected, and each sample was measured by a collection performance measuring device. This collection performance measuring device is configured by connecting a dust storage box to the upstream side of a sample holder to which a measurement sample is set, and connecting a flow meter, a flow rate adjusting valve, and a blower to the downstream side thereof. Additionally, a particle counter is used for the sample holder, and the number of dust particles on the upstream side and the number of dust particles on the downstream side of the measurement sample can be respectively measured through a switching cock. Moreover, a pressure gauge is provided in the sample holder to read the static pressure difference between the upstream and downstream of the sample.

To measure the collection performance, the dust storage box was filled with polystyrene standard latex powder with a diameter of 0.3 μm (manufactured by NAKALAI TESQUE, INC., 0.309U polystyrene 10 mass % solution diluted 200 times with distilled water) and the sample was set in the sample holder. Then, the air flow rate was adjusted with a flow rate adjustment valve so that the filter passage speed is 3 m/min, and the dust concentration was stabilized in the range of 10,000 to 40,000 pieces/2.83×10⁻⁴ m³ (0.01 ft³). A number D of dust upstream of the sample and a number d of dust downstream of the sample were measured three times per sample with a particle counter (KC-01E manufactured by RION Co., Ltd.), the following formula was used to obtain the collection performance (%), and the average value of 10 samples was calculated.

Collection efficiency (%)=[1−(d/D)]×100

(4) Comfort in Wearing

A protective hood and protective clothing were worn on a monitor, and a sensory evaluation was performed on the comfort in wearing, stuffiness, hood fixability, and visibility after working for 20 minutes in an environment of 30° C.×40% RH. The evaluation criteria are shown in Table 1.

TABLE 1

| | | | Hood | Ease in | |
|---|---|---|---|---|---|
| | Comfort | Stuffiness | fixability | wearing | Visibility |
| 3 | Can be worn | No | Close contact with | Can be worn | Does not obstruct |
| | without | stuffiness | no displacement | quickly | field of view even |
| | discomfort | | | | with head movement |
| 2 | Slight discomfort, | Somewhat | Slight displacement | Takes some | Slight displacement |
| | but no problem | stuffy | but adjustable | time to wear | with head movement, |
| | in wearing | | | | but adjustable |
| 1 | Discomfort | Stuffy | No close contact, | Takes time | Hood is displaced |
| | in wearing | | displaced | to wear | with head movement |

### Example 1

A polypropylene spunbonded nonwoven fabric (20 g/m², air permeability 320 cm³/cm²/sec) and a polypropylene electret meltblown nonwoven fabric (air permeability 150 cm³/cm²/sec, basis weight 20 g/m², average fiber diameter 2 μm) were bonded by spray coating (application amount 2.0 g/m²) using a hot-melt adhesive (MORESCOMELT: TN-367Z manufactured by MORESCO Corporation, melt viscosity of 1200 mPa·s at 140° C.) to obtain a spunbonded/meltblown two-layer laminate. Next, the meltblown nonwoven fabric surface of the two-layer laminate and a polypropylene spunbonded nonwoven fabric (20 g/m², air permeability 320 cm³/cm²/sec) were bonded again in a similar manner to obtain an SMS (spunbonded nonwoven fabric/meltblown nonwoven fabric/spunbonded nonwoven fabric) three-layer laminate.

The three-layer laminate was cut and sewn with a sewing machine to obtain a protective hood as shown in FIG. 6. An opening with a width of 15 cm and a length of 4.5 cm was provided in the front center of the protective hood (position corresponding to wearer's face), and a mask was attached below the opening. The mask had a protruding shape of 2 cm in the center, a nose wire was attached to the upper side, and 4 cm excess fabric was used to form a downward tuck. A latching tool (latching tool A) made of the same fabric having 2 cm in width and 130 cm was attached to the upper side of the opening by stitching. Additionally, a belt-shaped material made of the same fabric having a width of 2 cm was attached also on each of the right and left sides of the mask. The upper end of the belt-shaped material was superimposed on the latching tool provided on the upper side of the opening so that no excess force is applied thereon, and the overlapping portions were integrated by stitching.

Additionally, using the same three-layer laminate as the above protective hood, a front body, a back body, right and left sleeves, and a pair of right and left pants were made into a coverall, and the protective hood was attached thereto to obtain the protective clothing as shown in FIG. 8.

The physical properties and sewing specifications of the obtained protective clothing are shown in Table 2, and the comfort in wearing after working with the protective clothing on is shown in Table 3.

### Example 2

A method similar to Example 1 was performed except that a polyethylene microporous film (thickness 14 μm, melting point 137° C., microporous pore diameter 32 μm, water vapor transmission rate 380 g/m²·h, tensile strength (vertical) 40 N/50 mm, tensile strength (horizontal) 40 N/50 mm, tensile elongation (vertical) 10%, tensile elongation (horizontal) 8%, water pressure resistance 65 kPa, puncture strength 370 N/mm) was used instead of the polypropylene electret meltblown nonwoven fabric of Example 1 to obtain an SFS (spunbonded nonwoven fabric/film/spunbonded nonwoven fabric) three-layer laminate.

The obtained three-layer laminate was ultrasonically welded and sewn to produce a protective hood and protective clothing having the same shape as in Example 1. The physical properties and sewing specifications of the obtained protective clothing are shown in Table 2, and the comfort in wearing after working with the protective clothing on is shown in Table 3.

### Example 3

Using the three-layer laminate obtained in Example 2, a protective hood and protective clothing were produced (sewn with sewing machine) in a similar manner as in Example 2, except that a 100 μm polyester film subjected to antifogging hard coat processing was stitched to the hood opening. The physical properties and sewing specifications of the obtained protective clothing are shown in Table 2, and the comfort in wearing after working with the protective clothing on is shown in Table 3.

### Example 4

Using a spunbonded nonwoven fabric with a waterproof coating, a protective upper wear with a hood and protective trousers of the shape described in Example 1 were produced. The physical properties and sewing specifications of the obtained protective clothing are shown in Table 2, and the comfort in wearing after working with the protective clothing on is shown in Table 3.

### Example 5

The three-layer laminate used in Example 1 was cut and sewn with a sewing machine to obtain a protective hood as shown in FIG. 3. An opening with a width of 15 cm and a length of 11 cm was provided in the front center of the protective hood (position corresponding to wearer's face). A latching tool (latching tool A) made of the same fabric having a width of 2 cm and a length of 130 cm was attached to the upper side of the opening by stitching, and one end of a belt-shaped material (latching tool B) made of the same fabric having a width of 2 cm and a length of 53 cm was attached on each of the right and left sides of the opening. Then, a part of the belt-shaped material (latching tool B) and a part of the latching tool (latching tool A) provided on the upper side of the opening were superimposed on one another so that no excess force is applied thereon, and the overlapping portions were integrated by stitching.

Additionally, using a three-layer laminate similar to that of the protective hood, a front body, a back body, right and left sleeves, and a pair of right and left trousers were made into a coverall, and the protective hood was attached thereto to obtain the protective clothing as shown in FIG. 5.

The physical properties and sewing specifications of the obtained protective clothing are shown in Table 2, and the comfort in wearing after working with the protective clothing on is shown in Table 3.

### Example 6

The three-layer laminate used in Example 2 was cut and ultrasonically welded and sewn to produce a protective hood and protective clothing having the same shape as in Example 5. The physical properties and sewing specifications of the obtained protective clothing are shown in Table 2, and the comfort in wearing after working with the protective clothing on is shown in Table 3.

### Comparative Example 1

Protective clothing was produced in a similar manner as in Example 1, except that a commercially available polyethylene flashspun nonwoven fabric having one layer was used and a hood having the shape shown in FIG. 9 was used, and a wearing test was conducted. Note that although the hood is provided with an opening having a maximum width of 18 cm and a maximum length of 15 cm at a position corresponding to the wearer's forehead to the chin, the mask and the belt-shaped material on the upper side and the right and left sides of the opening (latching tool A, B) were not provided. The physical properties and sewing specifications of the obtained protective clothing are shown in Table 2, and the comfort in wearing after working with the protective clothing on is shown in Table 3.

### Comparative Example 2

Using the three-layer laminate obtained in Example 1, a protective hood and protective clothing were produced in a similar manner as in Example 1, except that the latching tool 5 (latching tool A), the mask 3, and the belt-shaped material 6 were not provided. Then, a wearing test was conducted. Note that the opening had a width of 15 cm and a length of 12 cm because no mask was provided. The physical properties and sewing specifications of the obtained protective clothing are shown in Table 2, and the comfort in wearing after working with the protective clothing on is shown in Table 3.

### Comparative Example 3

Using the three-layer laminate obtained in Example 1, a protective hood and protective clothing were produced in a similar manner as in Example 1, except that the latching tool 5 (latching tool A) on the forehead was not provided. The physical properties and sewing specifications of the obtained protective clothing are shown in Table 2, and the comfort in wearing after working with the protective clothing on is shown in Table 3.

TABLE 2

| | | | | Hood sewing specifications | | | | | |
|---|---|---|---|---|---|---|---|---|---|
| | Water vapor | | | | | | | String on right | |
| | transmission | Air | Collection | | Latching | | | and left of mask | |
| | rate | permeability | efficiency | Hood | tool on | | Eye | or right and left | Sewing |
| | (g/m² · h) | (cm³/cm²/sec) | (%) | shape | forehead | Mask | protection | of opening | method |
| Example 1 | 420 | 95 | 90 | Top of head and | Present | Present | Absent | Present | Machine sewing |
| | | | | side of head | | | | | |
| Example 2 | 350 | 0.1> | >99 | Top of head and | Present | Present | Absent | Present | Ultrasonic |
| | | | | side of head | | | | | welding sewing |
| Example 3 | 350 | 0.1> | >99 | Top of head and | Present | Present | Present | Present | Machine sewing |
| | | | | side of head | | | | | |
| Example 4 | 150 | 0.6 | 63 | Top of head and | Present | Present | Absent | Present | Machine sewing |
| | | | | side of head | | | | | |
| Example 5 | 420 | 95 | 90 | Top of head and | Present | Absent | Absent | Present | Machine sewing |
| | | | | side of head | | | | | |
| Example 6 | 350 | 0.1> | >99 | Top of head and | Present | Absent | Absent | Present | Ultrasonic |
| | | | | side of head | | | | | welding sewing |
| Comparative | 300 | 9.3 | 52 | [symbol] ht and left two pi [symbol] | Absent | Absent | Absent | Absent | Machine sewing |
| Example 1 | | | | | | | | | |
| Comparative | 420 | 95 | 90 | Top of head and | Absent | Absent | Absent | Absent | Machine sewing |
| Example 2 | | | | side of head | | | | | |
| Comparative | 420 | 95 | 90 | Top of head and | Absent | Present | Absent | Present | Machine sewing |
| Example 3 | | | | side of head | | | | | |

[symbol]

indicates data missing or illegible when filed

TABLE 3

| | Comfort in wearing (point) | | | | |
|---|---|---|---|---|---|
| | | | Hood | Ease in | |
| | Comfort | Stuffiness | fixability | wearing | Visibility |
| Example 1 | 3 | 3 | 3 | 3 | 3 |
| Example 2 | 3 | 3 | 3 | 3 | 3 |
| Example 3 | 3 | 3 | 3 | 3 | 3 |
| Example 4 | 1 | 1 | 3 | 3 | 3 |
| Example 5 | 3 | 3 | 3 | 3 | 3 |
| Example 6 | 3 | 3 | 3 | 3 | 3 |
| Comparative | 1 | 1 | 1 | 2 | 1 |
| Example 1 | | | | | |
| Comparative | 3 | 3 | 1 | 2 | 2 |
| Example 2 | | | | | |
| Comparative | 2 | 3 | 1 | 2 | 1 |
| Example 3 | | | | | |

### INDUSTRIAL APPLICABILITY

Since the protective hood of the present invention can be easily worn and has high degree of contact to the head and face, it can be suitably worn in an environment where harmful substances are present or in a clean room. Additionally, the protective hood can be suitably used in food and other manufacturing/processing factories.

### DESCRIPTION OF REFERENCE SIGNS

A: Bizygomatic breadth
B: Gnathion to glabella height
C: Stitched portion of latching tool 5 and belt-shaped material 6
1: Protective hood
2: Hood
3: Mask
5: Latching tool (Latching tool A)
6: Belt-shaped material
7: Arcuate shape
8: Nose wire
9: Tuck
10: Fabric forming portion corresponding to top of head
11: Fabric forming portion corresponding to side of head
12: Protective clothing
20: Opening
50: Latching tool (Latching tool B)

1. A protective hood comprising:
a hood that covers a head of a wearer;
an opening formed at a position corresponding to a face of the wearer; and
a latching tool A that can be latched around the head of the wearer and is provided on an upper side of the opening.

2. The protective hood according to claim 1, wherein
the hood has a latching tool B on each of right and left sides of the opening, and
the latching tool B is a belt-shaped material, a part of the latching tool B being connected to one of the right and left sides, and another part of the latching tool B being connected or being connectable to the latching tool A.

3. The protective hood according to claim 1 further comprising a mask that covers the nose and mouth of the wearer, wherein
the opening is formed by the hood and the mask, and
the mask is connected to the hood below the opening.

4. The protective hood according to claim 3 further comprising a belt-shaped material on each of right and left sides of the mask, wherein
the belt-shaped material is connected or is connectable to the latching tool A.

5. The protective hood according to claim 3, wherein the mask is made of a nonwoven fabric having a water vapor transmission rate of 200 g/m²·h or more and 2000 g/m²·h or less.

6. The protective hood according to claim 3, wherein the mask is made of a nonwoven fabric having an air permeability of 20 cm³/cm²/sec or more and 200 cm³/cm²/sec or less, and a dust collection efficiency of 80% or more.

7. The protective hood according to claim 1, wherein the hood is made of a nonwoven fabric having a water vapor transmission rate of 200 g/m²·h or more and 2000 g/m²·h or less.

8. The protective hood according to claim 1, wherein the hood is made of a nonwoven fabric having an air permeability of 20 cm³/cm²/sec or more and 200 cm³/cm²/sec or less, and a dust collection efficiency of 80% or more.

9. The protective hood according to claim 1, wherein the hood is formed by stitching together a fabric forming a portion corresponding to the top of the head and a fabric forming a portion corresponding to the side of the head.

10. The protective hood according to claim 1, wherein the protective hood is disposable.

11. Protective clothing comprising the protective hood according to claim 1 being attached.
